(19) United States
(12) Patent Application Publication
(10) Pub. No.: US 2025/0041939 A1
(43) Pub. Date: Feb. 6, 2025

(54) ASSEMBLY AND METHOD FOR ATOMIZING A METAL MELT AND METHOD FOR PRODUCING AN ASSEMBLY

(71) Applicant: Brose Fahrzeugteile SE & Co. KG, Coburg, Coburg (DE)

(72) Inventor: Jan SANDER, Meeder (DE)

(21) Appl. No.: 18/722,479

(22) PCT Filed: Dec. 15, 2022
(86) PCT No.: PCT/EP2022/086054

§ 371 Date: Aug. 27, 2024

(30) Foreign Application Priority Data
Dec. 20, 2021 (DE) 10 2021 214 726.7

(51) Int. Cl. B22F 9/08; B33Y 80/00

(52) U.S. Cl. CPC B22F 9/082; B33Y 80/00; B22F 2009/0876

(57) ABSTRACT

It is provided an assembly for atomizing a metal melt, comprising a target element to which the metal melt can be supplied for atomization, wherein the target element is additively manufactured. It is further provided a method for producing an assembly, a method for atomizing a melt of metal to powder, and a device for producing metal powder.

### BACKGROUND

This disclosure relates to an assembly for atomizing a metal melt, a method for producing an assembly for atomizing a metal melt, a method for atomizing a melt of metal to powder, and an apparatus for producing metal powder.

In the production of metal powder from a metal melt various methods with specific advantages and disadvantages are available. What is known are gas atomization methods, water atomization methods and the mechanical atomization via ultrasound or rotation.

In the gas atomization, metal melt is atomized by means of a high pressure gas jet. A mass of the gas used is a small fraction of a mass of the metal melt, which requires a high kinetic energy of the gas in order to atomize the metal melt. The compression of a gas is extremely energy-intensive and involves great losses, which makes gas atomization a cost-intensive method.

In the water atomization, water is used for atomization. By means of this method only non-spherical metal particles can be generated, which are unsuitable for many applications. Moreover, an atomization with water is not suitable for metals which react with water.

A mechanical atomization with an assembly can be performed on a target element, such as for example a disk, to which the metal melt can be supplied for atomization.

U.S. Pat. No. 4,456,444 A for example describes a rotating disk on which metal is poured in order to produce a metal powder. The rotating disk has a first protective layer made of ceramic in order to produce a thermal insulation. Above the first protective layer a second protective layer made of metal is provided, in order to protect the ceramic from the metal melt.

Such a method has a higher energy efficiency than gas atomization or water atomization, because due to the simple configuration less energy losses can occur. Moreover, there are not consumed any additional resources such as gas or water (apart from a protective gas possibly to be provided once).

Due to the contact of the metal melt with the disk during the atomization, the disk is heated by the metal melt. This requires temperature-resistant materials for the disk. Such materials, however, can contaminate the metal powder. Alternatively, the disk can be cooled. For example, a self-cooling disk is known from CN 1 100 539 001 A.

### SUMMARY

It is the object underlying the proposed solution to provide an improved assembly.

According to a first aspect of the proposed solution the object is achieved by an assembly for atomizing a metal melt with features as described herein.

Accordingly, the target element is additively manufactured. An additive manufacture can be achieved for example with a 3D printing method.

It is desirable to use a material for the target element with which the metal melt to be atomized by means of the assembly is not contaminated as far as possible. In particular, the target element can be made of the same material which is used for atomization. Hence, it can be a material which is atomizable.

In one embodiment, the target element is rotatably mounted about an axis of rotation. Alternatively or additionally, the assembly can include a sonotrode for introducing a mechanical vibration into the target element. The rotatable mounting of the target element can provide for rotating the target element in order to provide for the atomization of the metal melt on contact with the target element. The atomization of the metal melt can be effected by a centrifugal force radially to the axis of rotation.

By providing a sonotrode it can become possible to introduce mechanical vibrations into the target element by means of an excitation device for generating mechanical vibrations such as an ultrasonic generator. The atomization of the metal melt on contact with the target element then can be effected by the mechanical vibrations.

In one embodiment, the target element includes an atomizing portion on which the metal melt can be atomized, and a cooling assembly to be traversed by a gaseous medium, by means of which the atomizing portion can be cooled via the gaseous medium. The atomizing portion and the cooling assembly in particular can be formed in one piece. In principle, the target element can be any solid body made of metal. The atomizing portion can have the shape of a disk or circular plate. The cooling assembly likewise can be of disk-shaped design or have the shape of a circular plate. In particular, a radius of the atomizing portion and of the cooling assembly can be identical. By providing a cooling assembly there can be created an assembly which can be operated with a long service life and, if necessary, continuously without interruptions, so that the economy and the application possibilities of the assembly are improved.

With the additive manufacturing method for the target element, the target element and in particular the cooling assembly can be structured in such a way that by an active and/or passive cooling in operation of the assembly melting of the target element on contact with the metal melt is prevented. In the case of an active cooling, a gaseous medium can be actively supplied to the assembly for cooling. In the case of a passive cooling, the assembly can suck in gaseous medium, which can be used for cooling, due to its rotation in operation, which can open up a simple and inexpensive possibility for operating the assembly, because no additional devices are required for (actively) supplying the gaseous medium. In the active cooling, the gaseous medium used can be utilized to deflect melt particles which are flung away from the target element.

In one embodiment, the atomizing portion has an atomizing surface which interacts with the metal melt. The cooling assembly is arranged on a side of the atomizing portion which is disposed opposite the atomizing surface along the axis of rotation of the target element. In proper use of the assembly, in which metal melt is supplied to the assembly along the weight force, the cooling assembly can be arranged below the atomizing portion. The atomizing surface can be closed so that the metal melt cannot penetrate into the cooling assembly via the atomizing surface. The cooling assembly in particular can have a circumference around the axis of rotation which is at least as large as the circumference of the atomizing surface, so that the atomizing portion can be cooled effectively.

In one embodiment, the cooling assembly includes a plurality of blades which are arranged around the axis of rotation of the target element like a turbine. Due to the fact that the blades are arranged like a turbine, gaseous medium can be sucked into the cooling assembly during a rotation about the axis of rotation. The turbine-like arrangement of the blades hence can be configured to convey gaseous medium from an environment of the target element along a radial direction towards the axis of rotation.

For rotating the target element, the assembly can include a drive device such as for example a drive motor. The drive device can be designed to rotate the target element with a rotation speed between 10,000 to 100,000, in particular 30,000 to 50,000 revolutions per minute.

The assembly can be used in a housing of a device for producing metal powder, which is filled with protective gas. Protective gas can be provided to prevent that the metal melt or the melt particles or the metal powder are contaminated due to chemical reactions. The protective gas can comprise the gaseous medium which is used for cooling the atomizing portion.

Beside the atomizing portion and the cooling assembly, the target element can include a counter-portion which together with the atomizing portion forms a space along the axis of rotation in which the cooling assembly is arranged. Gaseous medium, for example the protective gas which has been conveyed by the plurality of blades towards the axis of rotation into the space, can exit from the space through at least one opening in the counter-portion. The at least one opening for example can be arranged on the axis of rotation. The target element can be manufactured from the atomizing portion, the cooling assembly and the counter-portion additively and in one piece.

Preferably, the rotation speed is high enough to generate a stream of the gaseous medium which provides a thermal capacity that is larger than a heat input from the metal melt onto the atomizing portion.

In one embodiment, at least one of the plurality of blades protrudes beyond the atomizing portion with an end portion radially to the axis of rotation. The at least one end portion can cause an improvement of the conveyance of the gaseous medium from the environment of the target element towards the axis of rotation.

In one embodiment, the cooling assembly includes at least one first nozzle element which protrudes from the atomizing surface and via which the gaseous medium can be applied onto the atomizing surface. The cooling assembly to be traversed by the gaseous medium hence in principle can be arranged on a side of the atomizing portion which is disposed opposite the atomizing surface along the axis of rotation. Individual elements, such as for example the at least one first nozzle element, however can penetrate the atomizing portion and protrude from the atomizing surface. The gaseous medium, which has been conveyed towards the axis of rotation by the plurality of blades, can be conveyed through the at least one first nozzle element out of the space between the atomizing portion and the counter-portion.

Since the gaseous medium is applied directly onto the atomizing surface, an improved cooling of the atomizing surface can become possible. The optional configuration with the plurality of blades can supplement the passive cooling via the blades with an active component, namely the application of the gaseous medium onto the atomizing surface. Alternatively, the gaseous medium can be actively supplied to the at least one first nozzle element via a device for generating a stream of the gaseous medium.

In one embodiment, the cooling assembly includes at least one second nozzle element which is arranged at an edge of the atomizing portion and via which the gaseous medium can flow out. After having traversed the cooling assembly, the gaseous medium can flow out through the at least one second nozzle element. Hence, the at least one second nozzle element in particular is suitable for an active cooling in which a stream of the gaseous medium is supplied to the cooling assembly. An arrangement of the at least one second nozzle element at an edge of the atomizing portion can provide for deflecting melt particles, which are flung away from the target element due to the centrifugal force and/or mechanical vibrations, on their flight path with a stream of the gaseous medium. The cooling assembly hence can be extended up to an edge of the atomizing portion and possibly beyond the same. The edge of the cooling assembly in particular can be an outer edge. The gaseous medium for example coming from the axis of rotation can flow radially away from the axis of rotation to the edge in order to exit from there through the at least one second nozzle element.

In one embodiment, a plurality of second nozzle elements is arranged at an edge of the atomizing portion. The plurality of second nozzle elements is aligned in such a way that the stream of the gaseous medium, which in operation of the cooling assembly flows out of the second nozzle element, generates a tornado-like stream formation around the target element. The tornado-like stream formation can be extended upwards along the axis of rotation from the cooling assembly via the atomizing portion so that the melt particles flung away can be deflected by the stream formation. The gaseous medium flowing out of the plurality of second nozzle elements hence can be utilized to generate a spin on the melt particles. With increasing distance to the atomizing portion along the axis of rotation a diameter of the stream formation can increase.

In operation, the flight path of the melt particles can be shortened (in opposite direction) or be extended (in the same direction) by choosing the direction of rotation of the target element in the opposite direction against the tornado-like stream formation or in the same direction with the tornado-like stream formation. In particular, shortening can be effected by a curvature of the flight path caused by the stream formation. The shortening of the flight path can be utilized to save installation space. An extension of the flight path can provide for longer cooling. A number, shape of the melt particles and/or the formation of satellites of the melt particles accordingly can be controlled via the direction of rotation of the target element, an outflow direction/quantity of the gaseous medium and also via a temperature of the medium. In principle, the assembly can include a control device for controlling at least one of these parameters.

In one embodiment, the cooling assembly is designed in such a way that the gaseous medium can be introduced into the cooling assembly parallel to the axis of rotation via at least one opening and can spread on the atomizing portion transversely to the axis of rotation. For (actively) supplying the gaseous medium to the cooling assembly, a device for generating a stream of a gaseous medium, for example a compression device, can be provided. The compression device for example can compress the protective gas in the housing of a device in which the assembly can be arranged, in order to introduce the same into the cooling assembly under pressure. With such an active supply of the gaseous medium, the rotation speed of the target element can be chosen independently of the need of gaseous medium for cooling.

In an alternative embodiment, the cooling assembly is designed in such a way that the gaseous medium is drawn in transversely to the axis of rotation via the turbine-like blades and flows out of the cooling assembly parallel to the axis of rotation.

In another embodiment, the cooling assembly includes at least one helical cooling channel. In principle, the cooling assembly can include cooling channels of any shape. With a helical cooling channel a particularly large surface of the atomizing portion can be covered effectively. The at least one helical cooling channel for example can be centered around the axis of rotation so that the gaseous medium can flow from the axis of rotation in a radial direction towards the outside through the at least one cooling channel.

For example, it is conceivable and possible to have the gaseous medium for active cooling flow into the cooling assembly parallel to the axis of rotation so that it can spread transversely to the axis of rotation. In addition, the cooling assembly can include turbine-like blades with which in operation gaseous medium is sucked in at the same time for active cooling, in order to additionally passively cool the atomizing portion. Cooling structures through which the gaseous medium flows for active cooling can be arranged between the blades arranged like a turbine and the atomizing portion. The cooling structures for example can include the at least one cooling channel.

In one embodiment, the target element includes an atomizing portion for atomizing the metal melt, on which at least one depression is provided, in which the metal melt supplied to the target element can accumulate for atomization. The at least one depression can be delimited by separating elements such as ribs or plateaus. The at least one depression likewise can include a groove or recesses in the atomizing portion. The at least one depression can be provided to provide a channel for the accumulated metal melt, via which the metal melt can spread on the atomizing portion.

In one embodiment, the at least one depression is formed radially to the axis of rotation. The metal melt then can spread in the at least one depression along a direction radially to the axis of rotation. During a rotation of the target element the metal melt can flow through the at least one depression to an edge of the atomizing portion. At the edge of the atomizing portion the metal melt can be flung away from the atomizing portion due to the centrifugal force. At least one of the separating elements, which delimit the at least one depression, can include a recess in the direction of rotation, into which the metal melt can be pressed due to a tangential force of the rotation, in order to ensure spreading of the metal melt along an exclusively radial direction due to the centrifugal force.

According to a second aspect of the proposed solution, the object is achieved by a method for producing an assembly for atomizing a metal melt. The method comprises the following steps: providing a metal powder and additive manufacture of a target element from the metal powder.

According to a third aspect of the proposed solution, the object is achieved by a method for atomizing a melt of metal to powder, which comprises the following steps: Providing an additively manufactured target element which is made of the same metal as the melt, pouring the melt onto the target element, and atomizing the melt by means of the target element.

The features of the assembly described in connection with the first aspect of the proposed solution likewise can be provided in the method according to the second aspect and in the method according to the third aspect of the proposed solution.

According to a fourth aspect of the invention, the object is achieved by a device for producing metal powder with an assembly according to the first aspect.

### BRIEF DESCRIPTION OF THE DRAWINGS

The idea underlying the proposed solution will be explained in detail below with reference to the exemplary embodiments illustrated in the Figures.

FIG. 1 shows a sectional view through a device for producing metal powder.

FIG. 2 shows a sectional view through an assembly comprising a sonotrode.

FIG. 3 shows a perspective view of an assembly comprising a plurality of blades.

FIG. 4 shows a perspective view of an assembly comprising a plurality of blades with end portions.

FIG. 5 shows a perspective view of an assembly comprising stream conductors and stream dividers.

FIG. 6 shows a cooling assembly comprising a cooling channel.

FIG. 7 shows a sectional view through an assembly with a first nozzle element.

FIG. 8A shows a top view of an assembly with a plurality of second nozzle elements and a first direction of rotation.

FIG. 8B shows a top view of an assembly with a plurality of second nozzle elements and a second direction of rotation.

FIG. 9A shows an atomizing portion with depressions.

FIG. 9B shows a first section I through an atomizing portion.

FIG. 9C shows a second section II through an atomizing portion.

FIG. 9D shows a third section III through an atomizing portion.

### DETAILED DESCRIPTION

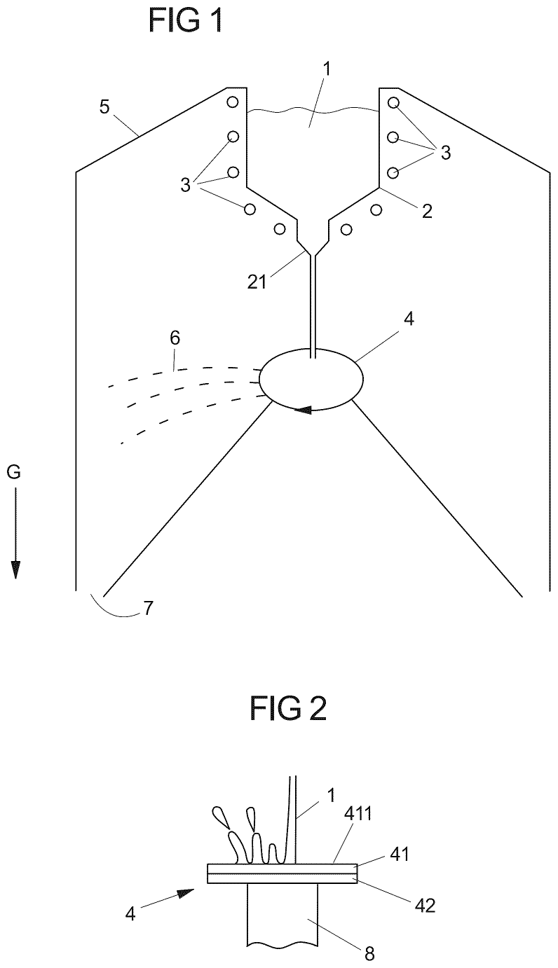

FIG. 1 shows a device for producing metal powder. The device includes a crucible 2 which is filled with metal melt 1. Additional metal can be supplied to the crucible 2 in liquid or solid form continuously or in batches. The crucible 2 can be heated with a plurality of heating elements 3 so that the metal melt 1 in the crucible 2 can be kept in a liquid state. At the crucible 2 an outlet valve 21 is provided, via which the metal melt 1 can be discharged from the crucible 2. The outlet valve 21 is adjustable in order to be able to regulate the amount of exiting metal melt 1. The metal melt 1 exiting from the crucible 2 forms a melt jet which is supplied to an assembly. The assembly includes a target element 4 on which the metal melt 1 of the melt jet is atomized.

The target element 4 is additively manufactured. It is also rotatably mounted about an axis of rotation R. As an alternative to the rotatable mounting or in addition thereto, the assembly includes a sonotrode 8 for introducing a mechanical vibration into the target element 4.

Due to a centrifugal force caused by the rotation and/or due to the mechanical vibrations, the metal melt 1 present on the target unit is ripped into individual melt particles 6 which are flung away from the target element 4. The melt particles 6 flung away fly along a trajectory away from the target element 4. During the flight along the trajectory the melt particles 6 solidify to form metal powder. A sufficient centrifugal force for the production of metal powder lies at a rotation speed of the target element 4 between 30,000 and 50,000 revolutions per minute, wherein these values depend on a distance to the axis of rotation in which the metal melt 1 is poured onto the target element 4.

The metal powder drops along the trajectory to a powder outlet 7 in which the metal powder is collected in order to be processed further. For example, the metal powder subsequently can be sorted or screened by a cyclone according to the particle size. The assembly is arranged in a housing 5 which is filled with a protective gas, so that for example chemical reactions of the metal melt 1 or of the melt particles 6 are prevented. The powder outlet 7 is provided at the housing 5 below (along the weight force G) the target element 4.

FIG. 2 shows a sectional view through the assembly. The target element 4 includes an atomizing portion 41 on which the metal melt 1 is atomized, and a cooling assembly 42 to be traversed by a gaseous medium, with which the atomizing portion 41 is cooled. The atomizing portion 41 and the cooling assembly 42 are formed in one piece.

The atomizing portion 41 has an atomizing surface 411 which is in contact with the metal melt 1. Due to the interaction of the metal melt 1 with the atomizing surface 411 a heat input into the target element 4 is effected. In particular when the target element 4 is made of the same metal as the metal melt 1, the heat input can lead to the melting of the target element 4. It therefore is provided that the cooling assembly 42 provides a stream of the gaseous medium whose thermal capacity is sufficient to discharge the heat input, so that a temperature of the target element 4 is kept above a melting temperature of the metal of which the target element 4 is made. The discharge of the heat input also can be advantageous when the metal melt 1 and the target element 4 are made of different metals. For even if the metal of the target element 4 has a higher melting temperature than the metal melt 1, for example temperature-dependent chemical reactions between the metal melt 1 and the target element 4 can be prevented by cooling.

The depicted assembly includes a sonotrode 8 with which mechanical vibrations can be introduced into the target element 4, which cause an atomization of the metal melt 1 at the target element 4. For introducing the vibrations into the target element 4, the sonotrode contacts the target element 4 in a contact point. The metal melt 1 is atomized in a direction radially away from an axis A, which is extended perpendicularly to the atomizing surface 411. It is likewise conceivable and possible that additionally or alternatively a mounting of the target element 4 is provided, which enables a rotation of the target element 4. The rotation can cause a centrifugal force which supports the atomization due to the mechanical vibrations.

The cooling assembly 42 is arranged on a side of the atomizing portion 41 which faces away from the atomizing surface 411. In the present case, this side is arranged on the side of the sonotrode 8. In a rotatably mounted target element 4, the side along the axis of rotation R can be disposed opposite the atomizing surface 411.

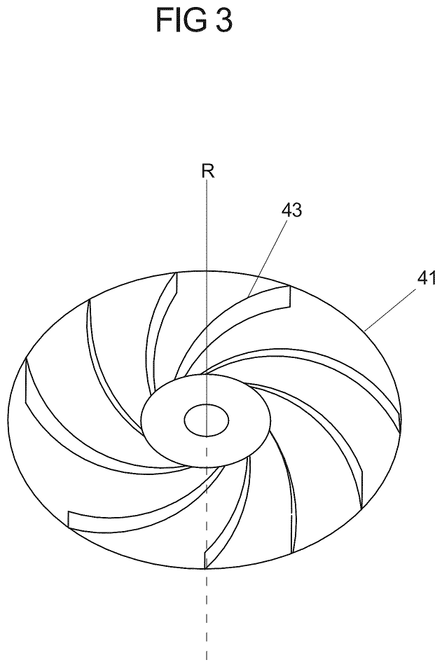

FIG. 3 shows a cooling assembly 42 with a plurality of blades 43 which are arranged around the axis of rotation R of the target element 4 like a turbine, so that during a rotation the target element 4 conveys gaseous medium via the blades 43 towards the axis of rotation R. The turbine-like arrangement of the blades 43 around the axis of rotation R in particular comprises an arc-shaped extension of the blades 43 radially to the axis of rotation R. The design of the blades 43 in principle is arbitrary.

The gaseous medium absorbs the heat input from the atomizing portion 41 so that the target element 4 is cooled via the gaseous medium. The blades 43 are arranged along the axis of rotation R below the atomizing portion 41 so that the gaseous medium flows along the atomizing surface 411, where the heat input is effected, as tightly as possible.

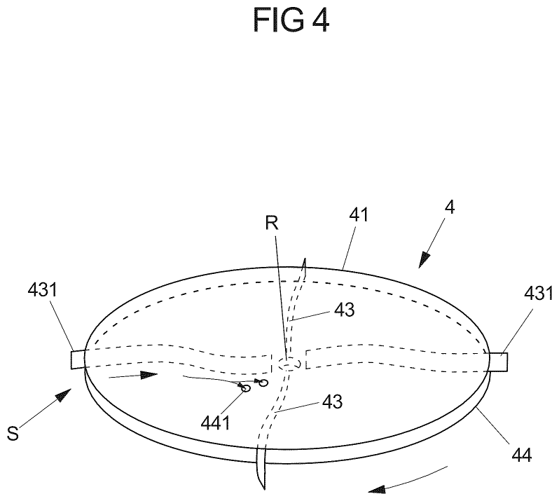

FIG. 4 shows another embodiment of a cooling assembly 42 with a plurality of blades 43. By way of example, the blades 43 are of wave-shaped design. The target element 4 comprises an atomizing portion 41 and a counter-portion 44, which is shifted in parallel relative to the atomizing portion 41 along the axis of rotation R, so that between the atomizing portion 41 and the counter-portion 44 a space is formed. In the space, the blades 43 are arranged.

The blades 43 are extended radially to the axis of rotation R of the target element 4. In addition, end portions 431 of the blades 43 optionally protrude radially to the axis of rotation R beyond the atomizing portion 41. A stream of the gaseous medium thereby can even better be sucked into the space.

The stream of the gaseous medium is introduced into the target element 4 along the blades 43 and flows out of the target element 4 via openings 411 in the counter-portion 44. The cooling assembly 42 hence is designed in such a way that the gaseous medium can be introduced into the cooling assembly 42 radially to the axis of rotation R and can spread on the atomizing portion 41 for absorbing a heat input from the atomizing portion 41 and then can flow out of the cooling assembly 42 parallel to the axis of rotation R via openings 441. The openings 441 are spaced apart from the axis of rotation R in such a way that they are arranged within an imaginary inner ring around the axis of rotation R, whose radius is smaller than 25% of the radius of the target element 4. Preferably, the openings 441 are arranged as close as possible to the axis of rotation R in order to make use of the cooling effect of the stream of the gaseous medium as efficiently as possible.

With an embodiment of the cooling assembly 42 as it is shown in FIG. 3 and FIG. 4 the target element 4 can be passively cooled via the gas stream, because the gas stream is provided solely by the rotation of the target element 4. What is particularly suitable for such a target element 4 is a disk-shaped atomizing portion 41 shown in the Figures. The counter-portion 44 of the target element 4 likewise can be of disk-shaped design.

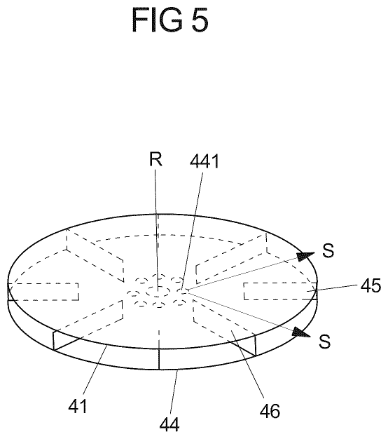

The target element 4 shown in FIG. 5 comprises a cooling assembly 42 with a plurality of stream dividers 45 and stream conductors 46, which are extended along a direction radially to the axis of rotation R of the target element 4. In the present case, the axis of rotation R merely is indicated by way of example. Alternatively, the stream conductors 46 and stream dividers 45 can be arranged radially to an axis A which is arranged perpendicularly to the atomizing surface 411 and is extended through a contact point between the sonotron 8 and the target element 4.

The stream dividers 46 and stream conductors 45 are arranged in a space delimited by the atomizing portion 41 and a counter-portion 44. A gaseous medium is introduced into the space via openings 441 in the counter-portion 44 parallel to the axis of rotation R and spreads at the atomizing portion 41 in the space perpendicularly to the axis of rotation R. The stream of the gaseous medium here is limited in its expansion by the stream conductors 46, so that a defined portion of the atomizing portion 41 can be cooled via each opening 441. Two stream conductors 46 each delimit a circular segment of the cooling assembly 42, at whose tip an opening 441 is arranged on the counter-portion 44. In principle, a group of openings 441 likewise can be provided at the tip. The opening 441 each is arranged within an imaginary inner ring around the axis of rotation R, whose radius is smaller than 25% of the radius of the target element 4. The stream within the respective circular segment is divided by the stream divider 45. The stream dividers 45 are extended radially to the axis of rotation R towards the opening 441, so that the stream coming from the opening 441 each is divided at the stream dividers 45.

The cooling assembly 42 hence is designed in such a way that the gaseous medium flows into the cooling assembly 42 parallel to the axis of rotation R via the openings 441 and can spread at the respective segments transversely to the axis of rotation R. The gaseous medium then flows out of the cooling assembly 42 to the outside transversely to the axis of rotation R. In principle, the target element 4 can be put into rotation by the stream of the gaseous medium. It is preferred, however, to put the target element 4 into rotation in the present case via a drive device, such as a drive motor, and/or to provide a sonotrode 8, in order to introduce mechanical vibrations into the target element 4 for atomization of the metal melt 1.

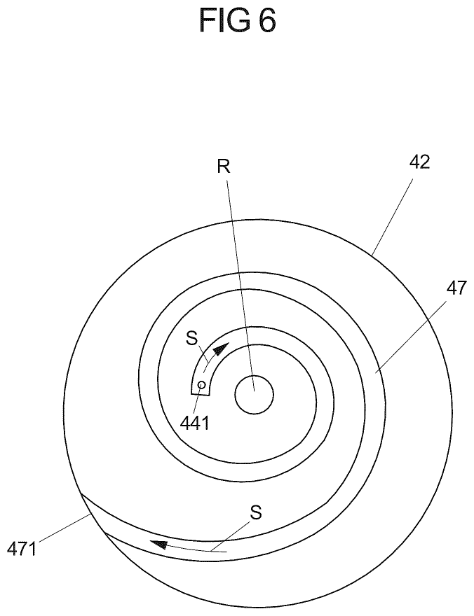

FIG. 6 shows an embodiment of the cooling assembly 42 with a cooling channel 47 which is helically arranged around the axis of rotation R. Alternatively, the cooling channel 47 can be helically arranged around an axis A which is extended perpendicularly to the atomizing surface 411 and through a contact point between the sonotrode 8 and the target element 4. The gaseous medium is introduced into the cooling channel 47 via an opening 441 close to the axis of rotation R and then flows away from the axis of rotation R in several helical windings in order to flow out through an outflow opening 481 at an edge of the cooling assembly 42. The cooling channel 47 is arranged in a space between the atomizing portion 41 and a counter-portion 44 with the opening 441. It is conceivable and possible to additionally provide a plurality of blades 43 in such a cooling assembly 42 or a cooling assembly 42 with an arbitrarily shaped cooling channel 47, wherein the cooling channel 47 or several cooling channels are arranged between the plurality of blades 43 and the atomizing portion 41.

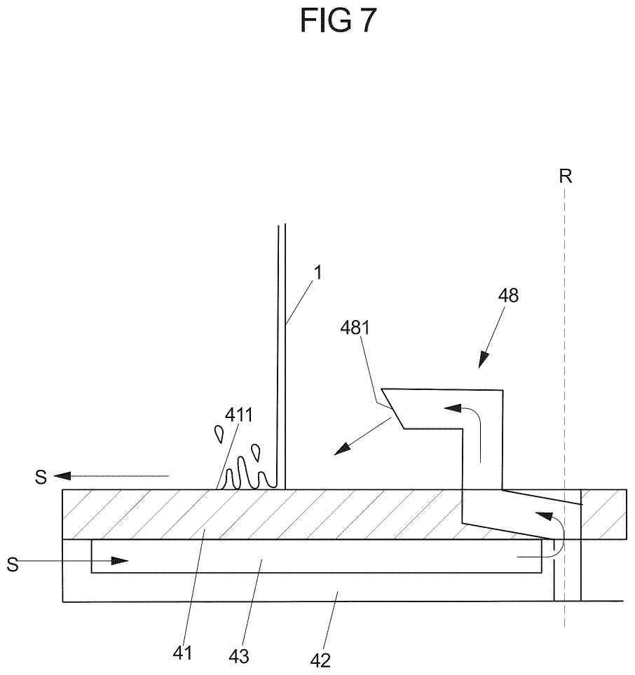

FIG. 7 shows a cross-section through a target element 4 with an atomizing portion 41 and a cooling assembly 42. The atomizing portion 41 has an atomizing surface 411 on which melt is atomized. The cooling assembly 42 is arranged on an opposite side of the atomizing portion 41 along an axis of rotation R of the target element 4.

The cooling assembly 42 includes a plurality of blades 43 with which gaseous medium is sucked in towards the axis of rotation R during a rotation of the cooling assembly 42. The described embodiment of the cooling assembly 42, however, also is suitable for a combination with alternative embodiments of the cooling assembly 42, which need not necessarily be designed for sucking in the gaseous medium into the cooling assembly 42 via blades 43.

The cooling assembly 42 includes a first nozzle element 48 which protrudes from the atomizing surface 411. At least part of the gaseous medium, which is used in the cooling assembly 42 for cooling the atomizing portion 41, flows out via the first nozzle element 48 in order to impinge on the atomizing surface 411. For this purpose, the first nozzle element 48 includes an outflow opening 481 which is directed onto the atomizing surface 411. Due to the stream of the gaseous medium over the atomizing surface 411, the atomizing portion 41 can be cooled directly with the gaseous medium on the atomizing surface 411.

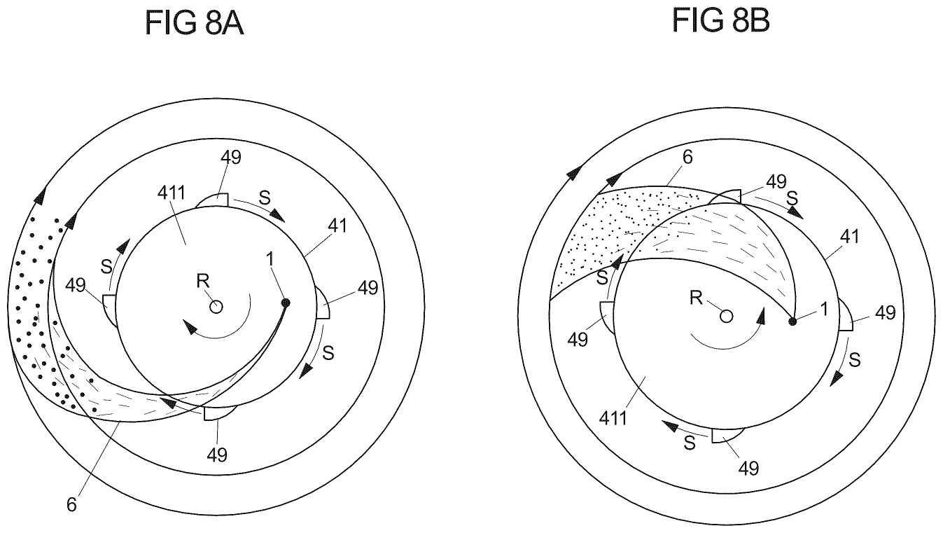

FIG. 8A and FIG. 8B each show a top view of the target element 4. In the top view it is shown how the metal melt 1 impinges on a point of the atomizing surface 411 which is spaced apart from an axis of rotation R of the target element 4. Because the target element 4 rotates (and because the point of impingement is spaced apart from the axis of rotation R), the metal melt 1 is accelerated along the direction of rotation and then flung away from the target element 4 due to the centrifugal force. The metal melt 1 thereby is ripped into melt particles 6 which form a particle stream which fans out with increasing distance to the axis of rotation R. It is shown by way of example that the melt particles 6 form a thread-like shape when they are flung away, and with increasing distance to the axis of rotation R form smaller particles, such as melt spheres, which by way of example are shown as dots.

The cooling assembly 42 includes a plurality of second nozzle elements 49, which are arranged at an edge of the atomizing portion 41 and via which the gaseous medium can flow out. In the present case, the gaseous medium for example can be introduced into the cooling assembly 42 parallel to the axis of rotation R via openings 441 and can spread on the atomizing portion 41 transversely to the axis of rotation R, while it absorbs heat input from the metal melt 1 into the atomizing portion 41, i.e. cools the atomizing portion 41. The gaseous medium then can flow out via the second nozzle elements 49.

The second nozzle elements 49 are configured to make the stream of the gaseous medium flow out in a direction with at least one of the following three direction components: a direction component along a direction of rotation of the target element 4, a direction component radially away from the axis of rotation R, and a direction component in the direction of the metal melt 1 (against the weight force G). The exiting gaseous medium effects that the particle stream of the melt particles 6 is deflected. Due to the configuration of the second nozzle elements 49 an outflow direction S and thereby in turn a trajectory of the melt particles 6 can be specified.

In the case of FIG. 8A, the outflow direction S of the gaseous medium includes all three of the above-mentioned direction components. The outflow direction S obliquely points upwards against the weight force G and outwards away from an edge of the atomizing portion 41 partly in the direction of the direction of rotation of the target element 4. Due to the depicted specification of the outflow direction S a stream formation of the gaseous medium is generated, which has the shape of a truncated cone whose truncated side is arranged on the atomizing portion 41. The exiting gaseous medium thus forms a tornado around the axis of rotation R. The rotation of the target element 4 is aligned parallel to the flow direction S of the stream formation. Melt particles 6 flung away from the target element 4 are entrained by the stream formation so that the trajectory of the melt particles 6 is extended. The melt particles 6 thereby can cool down for an extended period, whereby after solidification larger and more homogeneously shaped particles can be obtained.

In the case of FIG. 8B, the direction S of the stream of the gaseous medium is identical with the stream shown in FIG. 8A and described above. The rotation of the target element 4, however, is aligned against the direction S of the stream formation. Melt particles 6 flung away from the target element 4 therefore are braked by the stream formation so that the trajectory of the melt particles 6 is shortened. The melt particles 6 thereby are cooled abruptly, whereby finer powder particles can be obtained. In addition, installation space can be saved due to the shortened trajectory. For example, the housing 5 of the device, of which the assembly with the target element 4 is a part, can be designed smaller due to the saving in installation space.

Providing a rotation of the target element 4 in conjunction with the described stream formation is advantageous, but not absolutely necessary. The axis of rotation R in principle likewise can be an axis A which is arranged perpendicularly to the atomizing surface 411 and intersects a contact point between a sonotrode 8 and the target element 4. The melt particles 6 then are generated by mechanical vibrations.

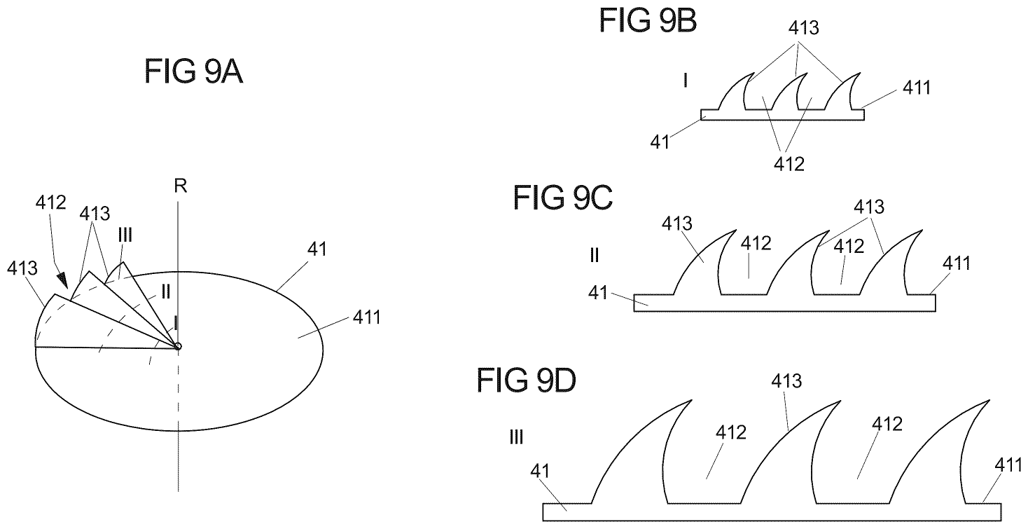

FIG. 9A shows a view of a structure of an atomizing portion 41 of the target element 4. The atomizing portion 41 in FIG. 9A includes depressions 412 which are formed between claw-shaped separating elements 413. In principle, the depressions 412 of course likewise can form grooves or recesses on the atomizing portion 41. The shape of the separating elements 413 likewise is arbitrary. The depressions 412 are arranged radially to the axis of rotation R so that they form a blossom-shaped structure around the axis of rotation R. The three dashed lines I, II and III represent intersection lines along a circumferential direction at three different distances to the axis of rotation R.

FIG. 9B shows a first cross-section along the intersection line I, FIG. 9C shows a second cross-section along the intersection line II, and FIG. 9D shows a third cross-section along the intersection line III.

A width of the depressions 412 along the circumferential direction becomes greater with increasing distance to the axis of rotation R. The separating elements 413 delimit the depressions 412 along the circumferential direction. The claw-shaped configuration of the separating elements 413 supports a discharge of metal melt 1 supplied to the target element 4 into the depressions 412. The separating elements 413 have ridge-shaped, radially extended edges which can cut into the melt jet in order to separate portions of the metal melt 1 and guide the same into the depressions 412.

The depressions 412 are formed such that metal melt 1 supplied to the target element 4 can accumulate therein. Due to a rotation of the target element 4, the metal melt 1 is flung out of the depressions 412. The volume of metal melt 1 accumulated in the depressions 412 in operation of the assembly therefore is a function of the rotation speed.

Due to the centrifugal force, the metal melt 1 within the depressions 412 is guided away from the axis of rotation R up to an edge of the atomizing portion 41 at which the metal melt 1 exits from the depressions 412. A size of the melt particles 6, which are detached from the metal melt 1 in the depressions 412 at the edge of the atomizing portion 41, is dependent on the rotation speed so that the rotation speed can be utilized to specify a size of the melt particles 6.

### LIST OF REFERENCE NUMERALS

1 metal melt
2 crucible
21 outlet valve
3 heating element
4 target element
41 atomizing portion
411 atomizing surface
412 depression
413 separating element
42 cooling assembly
43 blade
431 end portion
44 counter-portion
441 opening
45 stream divider
46 stream conductor
47 cooling channel
471 outflow opening
48 first nozzle element
481 outflow opening
49 second nozzle element
5 housing
6 melt particles
7 powder outlet
8 sonotrode
A axis
G weight force
R axis of rotation
S flow direction

1. An assembly for atomizing a metal melt, comprising a target element to which the metal melt can be supplied for atomization,
wherein the target element is additively manufactured.

2. The assembly according to claim 1, wherein at least one of the target element is rotatably mounted about an axis of rotation and/or that the assembly includes a sonotrodel for introducing a mechanical vibration into the target element.

3. The assembly according to claim 1, wherein the target element includes an atomizing portion, on which the metal melt can be atomized, and a cooling assembly to be traversed by a gaseous medium, by means of which the atomizing portion can be cooled via the gaseous medium.

4. The assembly according to claim 2, wherein the target element includes an atomizing portion, on which the metal melt can be atomized, and a cooling assembly to be traversed by a gaseous medium, by means of which the atomizing portion can be cooled via the gaseous medium, wherein the atomizing portion and the cooling assembly are formed in one piece, wherein the atomizing portion has an atomizing surface which interacts with the metal melt, and that the cooling assembly is arranged on a side of the atomizing portion which is disposed opposite the atomizing surface along the axis of rotation.

5. The assembly according to claim 2, wherein the target element includes an atomizing portion, on which the metal melt can be atomized, and a cooling assembly to be traversed by a gaseous medium, by means of which the atomizing portion can be cooled via the gaseous medium, wherein the atomizing portion and the cooling assembly are formed in one piece, wherein the cooling assembly includes a plurality of blades which are arranged around the axis of rotation of the target element like a turbine so that during a rotation around the axis of rotation gaseous medium is sucked into the cooling assembly.

6. The assembly according to claim 5, wherein least one of the plurality of blades protrudes beyond the atomizing portion with an end portion radially to the axis of rotation.

7. The assembly according to claim 4, wherein the cooling assembly includes at least one first nozzle element which protrudes from the atomizing surface and via which the gaseous medium can be applied onto the atomizing surface.

8. The assembly according to claim 3, wherein the cooling assembly includes at least one second nozzle element which is arranged at an edge of the atomizing portion and via which the gaseous medium can flow out.

9. The assembly according to claim 8, further comprising plurality of second nozzle elements which are arranged at the edge of the atomizing portion and are aligned in such a way that the stream of the gaseous medium, which in operation of the cooling assembly flows out of the plurality of second nozzle elements, can generate a tornado-like stream formation around the target element.

10. The assembly according to claim 3, wherein the cooling assembly is designed in such a way that the gaseous medium can be introduced into the cooling assembly parallel to the axis of rotation via at least one opening and can spread on the atomizing portion transversely to the axis of rotation.

11. The assembly according to claim 3, characterized in that the cooling assembly includes at least one helical cooling channel.

12. The assembly according to claim 1, wherein the target element includes an atomizing portion for atomizing the metal melt, on which at least one depression is provided, in which the metal melt supplied to the target element can accumulate for atomization.

13. The assembly according to claim 2, the target element includes an atomizing portion for atomizing the metal melt, on which at least one depression is provided, in which the metal melt supplied to the target element can accumulate for atomization, wherein the at least one depression is formed radially to the axis of rotation.

14. A method for producing an assembly for atomizing a metal melt, comprising the following steps:
providing a metal powder, and
additively manufacturing a target element from the metal powder.

15. A method for atomizing a melt of metal to powder, comprising the following steps:
providing an additively manufactured target element which is made of the same metal as the melt,
pouring the melt onto the target element, and
atomizing the melt with the target element.

16. A device for producing metal powder with an assembly according to claim 1.

17. The assembly according to claim 3, wherein the cooling assembly includes at least one second nozzle element which is arranged at an edge of the atomizing portion and via which the gaseous medium can flow out.

18. The assembly according to claim 17, further comprising a plurality of second nozzle elements which are arranged at the edge of the atomizing portion and are aligned in such a way that the stream of the gaseous medium, which in operation of the cooling assembly flows out of the plurality of second nozzle elements, can generate a tornado-like stream formation around the target element.

19. The assembly according to claim 3, wherein the atomizing portion and the cooling assembly are formed in one piece.
